(19) United States
(12) Patent Application Publication
(10) Pub. No.: US 2004/0053138 A1
(43) Pub. Date: Mar. 18, 2004

(54) Overcharge protection of nonaqueous rechargeable lithium batteries by cyano-substituted thiophenes as electrolyte additives

(76) Inventors: Ralph Otterstedt, Goslar (DE); Stephan Kirchmeyer, Leverkusen (DE); Lutz Brassat, Leverkusen (DE)

Correspondence Address: BAYER CHEMICALS CORPORATION, PATENT DEPARTMENT, 100 BAYER ROAD, PITTSBURGH, PA, 15205-9741, US

(21) Appl. No.: 10/660,846

(22) Filed: Sep. 12, 2003

(30) Foreign Application Priority Data
Sep. 16, 2002 (DE) 10244589.3

(51) Int. Cl. H01M 10/40; H01M 4/52; H01M 4/58; H01M 4/40

(52) U.S. Cl. 429/307; 429/327; 429/231.4; 429/231.8; 429/231.95; 429/223; 429/231.1

(57) ABSTRACT

The invention relates to the use of cyano-substituted thiophenes as electrolyte additives for protecting nonaqueous, rechargeable lithium batteries from overcharging, and lithium batteries comprising these additives.

### BACKGROUND OF THE INVENTION

1. Field of the Invention

The invention relates to the use of special electrolyte additives for protecting nonaqueous, rechargeable lithium batteries from overcharging, and lithium batteries comprising these additives.

2. Brief Description of the Prior Art

The demand for rechargeable batteries with increasingly high energy density has resulted in the development of rechargeable lithium batteries. While the use of lithium is associated with high energy density, high battery voltage and good shelf-life, it also associated with safety problems. In particular, the battery systems comprising lithium metal or lithium alloys as anode material are limited to primary batteries and small battery sizes, owing to safety problems.

A particular type of lithium battery, the so-called lithium ion or rocking chair type, has been commercially available since 1993. Since it can dispense with lithium metal or lithium alloys as the anode, it is the preferred rechargeable energy source for many electronic applications in the consumer sector. Lithium ion batteries use two different intercalation compounds for the active anode or cathode material. 3.6 V lithium ion batteries, based on LiCoO₂ and pregraphitic carbon as electrode materials, are commercially available. A large number of other lithium transition metal oxides is suitable as cathode material, e.g. LiNiO₂ and LiMn₂O₄. A large number of carbon-containing compounds is also suitable as anode material, including coke and pure graphite. The above-mentioned products use nonaqueous electrolytes which consist of conductive salts, such as LiBF₄ or LiPF₆, and solvent mixtures, for example of ethylene carbonate, propylene carbonate, diethyl carbonate and ethyl methyl carbonate.

As used herein, the terms “anode material” and “cathode material” relate to the electrochemical functionality of the electrochemically active material during discharge of the battery (by definition, oxidation takes place at the anode and reduction at the cathode).

Lithium batteries are sensitive to misuse, especially to overcharging, with the maximum permissible cell voltage being exceeded during recharging. During the overcharging of a rechargeable lithium battery, more lithium is extracted from the active cathode material and accordingly more lithium is introduced into the anode material than during a charging process which is carried out only to the maximum permissible cell voltage. As a result of the overcharging, both electrodes can become thermally less stable. The anode becomes less stable due to the incorporation or the deposition of reactive lithium metal. With increasing extraction of lithium, the cathode becomes susceptible to decomposition with loss of oxygen. The overcharging also results in heating of the battery since a major part of the electrical energy supplied is dissipated instead of being stored. The decrease in the thermal stability of the active materials during overcharging in conjunction with the heating of the battery by dissipation of the electrical energy supplied can lead to thermal runaway of the battery and fire.

Battery chargers are usually electronically equipped so that overcharging of the battery is prevented. Nevertheless, many battery manufacturers have decided to introduce further safety devices in each individual battery for improving the protection from overcharging, in the event of failure or manipulation of the charger. In this context, there are currently various approaches.

For example, U.S. Pat. No. 4,943,497 describes an internal disconnection device which disconnects the power supply as soon as the pressure in the interior of the battery exceeds a certain value. Various gas-producing agents can be used for producing sufficient gas for triggering the disconnection device above a certain voltage in the event of overcharging.

Another approach comprises introducing into the battery a device which limits the charging current or the charging voltage during overcharging. For example, it is possible to use a resistor having a positive temperature coefficient (PTC resistor), whose resistance increases sharply with a temperature increase in the battery and thus limits the charging current (U.S. Pat. No. 5,783,326).

The disadvantage of the above-mentioned approaches is that the batteries require additional components which technically complicate the batteries and thus make them more expensive. Possibilities have therefore been sought for limiting the charging current of the batteries without additional components in the technical design.

JP-A 2000 077 061 describes in this context a double anode layer comprising a conductive layer and a layer containing a conductive additive, a binder and a substance which decomposes on overcharging so that the electrical contact with the anode is broken and the internal resistance of the battery increases.

In EP-A 1 035 612, salt-based compounds are used as additives for improving the properties of electrochemical cells. In the event of overcharging, the presence of selected additives results, in the formation of a film on the cathode. This film reacts in a controlled manner with the cathode after the disconnection responds and thus reduces the “overpotential” by internal spontaneous discharge.

Furthermore, it has been proposed to use certain redox-active additives in rechargeable lithium batteries in order to protect the battery from overcharging. For this purpose, the additives must be capable of undergoing a reversible oxidation/reduction reaction above a certain voltage, i.e. the oxidized and the reduced species of the additive must be chemically stable. Some benzene derivatives are proposed as suitable additives (EP-A.0 746 050, JP-A 07 302 614).

WO 01/03226 describes organic compounds having an HOMO energy of from −8.5 to −11.0 eV and an LUMO energy of from −0.135 to 3.5 eV as suitable for ensuring outstanding safety and long-lasting reliability of nonaqueous secondary cells.

Another possibility for limiting the charging current in the batteries themselves comprises adding a small amount of a suitable polymerizable monomeric additive to the electrolyte of a rechargeable lithium battery in order to protect it from overcharging. The additive polymerizes at voltages above the maximum permissible cell voltage, of the battery, i.e. during overcharging, with formation of a blocking polymer film which increases the internal resistance of the battery. As in the case of a PTC resistor, the charging current can be sufficiently limited to protect the battery from further overcharging. EP-A 0 759 641 mentions biphenyl as preferred additive, which ensures satisfactory overcharge protection at a test temperature of 21° C. up to 4.2 V maximum permissible cell voltage, without adversely affecting the cycle life.

U.S. Pat. No. 6,033,797 describes the use of similar polymerizable monomer additives, once again preferably biphenyl, as gas-producing agents for triggering an internal electrical disconnection device in certain lithium ion batteries in the event of overcharging.

EP-A 0 878 861 likewise describes the use of polymerizable additives for discharging overcharged batteries “automatically” to a safe charge state. The resulting conductive polymer first forms an ion-blocking film and thus increases the internal resistance of the battery. When, however, sufficient polymer has been formed to bridge the gap between anode and cathode, the electrically conductive polymer can cause a mild internal short-circuit, which effects a slow and safe spontaneous discharge. In addition to biphenyl, furan and 3-chloro-thiophene are also preferred additives here.

Further approaches with the use of polymerizable electrolyte additives for protection from overcharging can be found in the literature. For example, the use of polymerizable electrolyte additives which, on overcharging, generate sufficient heat to melt the separator before the battery reaches a dangerous charge state is described (cf. EP-A 746 050). In JP-A 11 097 059 and JP-A 09 232 001, 2-methyl-1,3-butadiene, styrene or bromobenzene and aromatic compounds, such as naphthalene, anthracene and phenanthrene, are preferably used in an attempt to protect the battery by polymerization during overcharging.

The disadvantage of the use of biphenyl derivatives as polymerizable additives is that, on the one hand, they are not suitable for batteries having a maximum permissible cell voltage of more than 4.2 V for use in the intended manner and, on the other hand, they are not suitable for even slightly elevated temperatures. In this context, U.S. Pat. No. 6,704,777 discloses, as polymerizable additives which are suitable for higher voltages and/or elevated temperatures, phenyl-R-phenyl compounds, in which R is an aliphatic hydrocarbon or a fluorine-substituted biphenyl compound, and 3-thienyl-acetonitrile.

However, the additives used to date all have the disadvantage that they display their irreversible effect at a voltage which is only slightly above the permissible cell voltage of 4.2 V, i.e. the maximum permissible cell voltage for use in the intended manner, so that the battery becomes completely useless even on slight overcharging.

Furthermore, in the case of many of the additives used to date, the fact that a high irreversible capacitance occurs during the first charging cycle is disadvantageous.

There was therefore a need for electrolyte additives in rechargeable lithium batteries which are also suitable for use at higher temperatures, have a low irreversible capacitance during the first charging cycle and display their irreversible effect only at higher voltages, in particular only at those which are far above the maximum permissible cell voltage for use in the intended manner, with this effect beginning, however, in good time before thermal runaway of the battery.

It was therefore the object to provide or to find electrolyte additives which meet these requirements and to provide lithium batteries which comprise these electrolyte additives.

### SUMMARY OF THE INVENTION

Surprisingly, it has now been found that thiophenes substituted by at least one cyano group react on an overcharged cathode material of a lithium battery from a voltage above the maximum permissible cell voltage for use in the intended manner and substantially slow down a further increase in the voltage so that irreversible overcharge protection is effected.

The present invention therefore relates to a rechargeable lithium battery having a maximum permissible cell voltage for use in the intended manner, comprising

an anode comprising, preferably substantially consisting of, a material which is capable of incorporating lithium ions and releasing them again,

a cathode comprising, preferably substantially consisting of, a material which is capable of releasing lithium ions and incorporating them again,

a separator,

a nonaqueous electrolyte substantially comprising one or more solvents and/or one or more conductive salts optionally embedded in a polymeric gel matrix,

characterized in that the nonaqueous electrolyte additionally comprises a thiophene of the general formula (I)

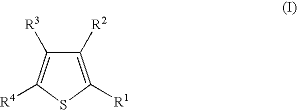

in which

R¹ to R⁴, independently of one another, are H, C₁-C₁₈-alkyl, C₁-C₁₈-haloalkyl, C₁-C₁₈-alkoxy, C₁-C_{1 8}-haloalkoxy, halogen or pseudohalogen, preferably, independently of one another, are H, C₁-C₆-alkyl, C₁-C₆-fluoroalkyl, C₁-C₆-alkoxy, C₁-C₆-fluoroalkoxy, F, Cl or CN, particularly preferably, independently of one another, are H, with the proviso that at least one of the radicals R¹ to R⁴ is CN.

### BRIEF DESCRIPTION OF THE DRAWINGS

FIG. 1 shows a comparison of the variation of the cell voltage U after charging to 4.3 V with further charging at 1 C. In the figure, the cell voltage U is plotted in V (volts) against the time t in s (seconds). Curves 1 to 5 correspond in each case to the variation in the cell voltage.

### DETAILED DESCRIPTION OF THE INVENTION

In the context of the invention, C₁-C₆-alkyl represents linear or branched alkyl radicals, among which methyl, ethyl, n-propyl, isopropyl, n-butyl, tert-butyl, sec-butyl, n-pentyl, 1-methylbutyl, 2-methylbutyl, 3-methylbutyl, 1-ethylpropyl, 1,1-dimethylpropyl, 1,2-dimethylpropyl, 2,2-dimethylpropyl or n-hexyl are mentioned by way of example. C₁-C₁₈-Alkyl is moreover, for example, n-heptyl, n-octyl, 2-ethylhexyl, n-nonyl, n-decyl, n-undecyl, n-dodecyl, n-tridecyl, n-tetradecyl, n-hexadecyl or n-octadecyl. In the context of the invention, C₁-C₆-fluoroalkyl represents, for example, the radicals described above for C₁-C₆-alkyl, in monofluorinated or polyfluorinated to perfluorinated form, and C₁-C₁₈-haloalkyl moreover represents the radicals which are likewise described above for C₁-C₁₈-alkyl and which are monosubstituted or polysubstituted by F, Cl, Br or I, it also being possible for different halogen substituents to occur in one radical. C₁-C₆-Alkoxy, C₁-C₆-fluoroalkoxy and C₁-C₁₈-alkoxy and C₁-C₁₈-haloalkoxy are, for example, alkoxy groups which are derived from the abovementioned corresponding alkyl or halo/fluoroalkyl groups by bonding them to thiophene via an oxy group. In the context of the invention, halogen is to be understood as meaning F, Cl, Br or I and pseudohalogen is, for example, CN (cyano), SCN or OCN. The above list serves as an exemplary explanation of the invention and is not to be considered as definitive.

According to the invention, a polymeric gel matrix is for example understood to be a polymeric electrolyte. Suitable polymeric electrolytes are polar or non-polar polymers and mixtures thereof, such as for example polyethylene oxide (PEO), poly(methoxy-ethoxyethoxy phosphazene) (MEEP) optionally crosslinked with polyethylene oxide (PEO) (PEO-crosslinked MEEP), poly(methyl methacrylate) (PMMA), polyacrylonitrile (PAN) or poly(vinylidene fluoride) (PVdF). According to the invention, either one or more conducting salts can be embedded in a polymeric gel matrix without a solvent or the polymeric gel matrix can be used for “plasticizing” the liquid electrolyte, i.e. for macroscopically immobilizing the electrolyte. Two-phase mixtures of non-polar polymers and polar polymers, such as for example mixtures of styrene/butadiene rubbers and acrylonitrile/butadiene rubbers (SBR-NBR), or core/shell polymers, such as for example a poly(vinyl pyrrolidone) core with a polybutadiene shell, are suitable for use as the polymeric gel matrix.

The invention preferably relates to a rechargeable lithium battery, characterized in that the nonaqueous electrolyte comprises from 0.01 to 10% by volume, particularly preferably from 1 to 7% by volume, particularly preferably from 2 to 5% by volume, of a thiophene of the general formula (I).

The anode of the rechargeable lithium battery according to the invention preferably substantially comprises

metallic lithium or

alloys containing metallic lithium or

carbon-like, optionally graphitic and non-graphitic materials or

carbon-based materials which contain further nonmetallic components in addition to carbon or

ternary compounds of boron, carbon and nitrogen or

oxides or sulphides of main group and subgroup elements.

In the context of the invention, alloys containing metallic lithium may be alloys of lithium with at least one element selected from the group of Al, Sn, Mg, Bi, Pb, Sb, In, Mn or Cd, and carbon-like, optionally graphitic and non-graphitic materials are to be understood as meaning, for example, materials such as coke, pyrolytic carbon, natural graphite, synthetic graphite, mesocarbon microbeads, graphitized mesophase spherules, gas phase-grown carbon, glassy carbon, carbon fibres, e.g. comprising polyacrylonitrile, pitch, cellulose or gas phase-grown carbon, amorphous carbon, organic matter baked carbon, carbon nanotubes, carbon black, calcined pitch, calcined coke and calcined synthetic and natural polymers. In the context of the invention, carbon-based materials containing further nonmetallic components may contain, in addition to carbon, for example further nonmetallic components selected from O, B, P, N, S, SiC, B₄C in an amount of up to 10 percent by weight, and BC₂N may be mentioned by way of example as a ternary compound of boron, carbon and nitrogen.

The cathode of the rechargeable lithium battery according to the invention preferably substantially comprises one or more transition metal chalcogenides or one or more mixed oxides of lithium and one or more transition metals and/or main group metals.

In the context of the invention, transition metal chalcogenides, such as TiS₂, MoS₂, Co₂S₅, V₂O₅, MnO₂ or CoO₂, and mixed oxides, such as LiMnO₂, LiMn₂O₄, LiCoO₂, LiNiO₂, LiNi₁₋ₓCoₓO₂, LiMn₂₋ₐX¹ₐO₄, LiMn_{2-a-b}X¹ₐY_{b}O₄, LiNi_{1-c-d}X²_{c}Y²_{d}O₂ or LiₑCo_{f}V_{1-f}O_{g}, may be mentioned by way of example for cathode materials,

in which

x is a number from 0 to 1,

X¹ and Y¹ may be identical or different and are selected from Na, Zr, Cu, Zn, Al, Ni, Co, Mg, Ti, Fe, Cr, V, Nb and Ta,

a and b are a number from 0 to 2, with the proviso that the sum of a and b is a number from 0 to 2,

X² and U² may be identical or different and are selected from Al, Mn, Co, Mg, Ti, Fe, Cu, Ag, Ga, In, Sn, Cr, V, Nb and Ta,

c and d are a number from 0 to 1, with the proviso that the sum of c and d is a number from 0 to 1,

e is a number from 0 to 1.2,

f is a number from 0.9 to 0.98 and

g is a number from 2 to 2.3.

In the context of the invention, particularly preferred mixed oxides as cathode materials are LiNi₁₋ₓCoₓO₂, LiNi_{1-x-y}CoₓAl_{y}O₂ or LiNi_{1-x-y}Mn_{z}O₂,

in which

x is a number from 0.05 to 0.5,

y is a number from 0 to 0.3 and

z is a number from 0 to 0.5,

or mixtures of these with one another or mixtures of these with other mixed oxides of lithium with transition metals and/or main group metals.

The separator of the rechargeable lithium battery according to the invention is preferably a porous polymer membrane or porous glass, where porous in this context is to be understood in the sense of permeable.

A separator may be one which has a so-called shut-down functionality, i.e. protection from overheating. When a certain temperature is exceeded, the so-called shut-down temperature, the separator breaks down in its microporous structure, for example as a result of melting, the permeability is lost and the internal resistance of the battery increases. Thus, overheating of the battery and resulting adverse consequences are irreversibly avoided.

Examples of porous polymer membranes which can be used as separators in the rechargeable lithium batteries according to the invention are polyolefins, such as polypropylene or polyethylene; the use of glass wool may be mentioned by way of example for separators of porous glass.

The nonaqueous electrolyte of the rechargeable lithium battery according to the invention preferably comprises one or more solvents selected from the group of the esters of carbonic acid, esters or nitriles of carboxylic acids, lactones, ethers, alkanes or perfluorinated alkanes and one or more conductive salt(s) selected from LiBF₄, LiPF₆, LiAsF₆, LiClO₄, lithium salts of perfluorinated carboxylic acids and perfluorinated alkanesulphonic or arylsulphonic acids, lithium-bisfluoroalkylsulphonylimides, lithium-trisfluoroalkylsulphonylmethides, lithium fluoroalkylphosphates, lithium bis(oxalato)borates, lithium bis((salicylato)borates) or comprises these optionally embedded in a polymeric gel matrix.

Particularly preferably, the nonaqueous electrolyte comprises, as a solvent, ethylene carbonate, propylene carbonate, diethyl carbonate, dimethyl carbonate, ethyl methyl carbonate or vinylene carbonate or mixtures of at least two of these carbonic esters.

Preferred conductive salts in addition to LiBF₄, LiPF₆, LiAsF₆ and LiClO₄ are, for example, perfluorinated carboxylic or sulphonic acids, such as CF₃CO₂Li and CF₃SO₃Li, lithium fluoroalkylphosphates, such as Li[(C₂F₅)₃PF₃], lithium-bisfluoroalkylsulphonylimides, such as Li[N(SO₂CₙH₂ₙ₊₁₋ₚFₚ)(SO₂CₙH_{2n+1-q}F_{q})], lithium-trisfluoroalkylsulphonylmethides, such as Li[C(SO₂CₙH₂ₙ₊₁₋ₚFₚ)(SO₂CₙH_{2n+1-q}F_{q})(SO₂CₙH₂ₙ₊₁₋ᵣFᵣ)],

in which

n in the individual radicals, independently of one another, are integers from 1 to 4 and

p, q and r, independently of one another, are integers from 1 to 9, with the proviso that p, q and r may in each case not be more than 2n+1.

The present invention preferably relates to a rechargeable lithium battery having a maximum permissible cell voltage of 4 V or higher for use in the intended manner.

Advantageously, the irreversible protection from overcharging begins only above this maximum permissible cell voltage for use in the intended manner, also referred to below as permissible cell voltage. The thiophenes of the general formula (I) react with the overcharged cathode material of the rechargeable lithium battery according to the invention, preferably at voltages of 4.7 V or higher, particularly preferably at 4.85 V or higher, especially preferably at 4.9 V or higher, with the result that a further increase in the voltage is substantially slowed down. Consequently, a sufficient margin from the permissible cell voltage is ensured so that the battery actually becomes useless only when clearly overcharged and is not irreversibly damaged or even rendered completely useless as in already known systems at voltages which are only slightly above the permissible cell voltage.

Surprisingly, it has moreover been found that the reversibility of the charging/discharging process is not substantially impaired in the first cycle by the addition of the thiophenes.

It is assumed that the additives in the rechargeable lithium batteries according to the invention do not display their effect for protecting the battery from overcharging and its consequences by polymerization, but rather undergo an irreversible chemical reaction in another manner, are preferably oxidized, above a certain voltage quantified more exactly in the preceding section. This has the advantage that this chemical reaction, preferably oxidation, cannot be initiated unintentionally at elevated temperature. As a result of this, the rechargeable lithium batteries according to the invention can also withstand higher temperatures and can be used at these temperatures without any difficulties. Protection from overheating can be ensured independently thereof in a controlled manner by the shut-down functionality of the separator already explained above.

The assumption described above serves for explaining the invention and is not to be considered as a restriction of the concept of the invention. The present invention is surprising in that the oxidation potential of, for example, 3-cyanothiophene, which is one of the particularly preferred thiophenes of the general formula (1), is given in the literature as 5.75 V. Measurement was carried out in acetonitrile on platinum against a saturated calomel electrode (2.46 V), corresponding to 5.75 V against a lithium electrode (A. F. Diaz and J. Bargon, “Electrochemical synthesis of conducting polymers”, Handbook of Conducting polymers, Vol. 1; Ed. T. A. Skotheim; Marcel Dekker, New York and Basle 1986, pages 81-115). Surprisingly, however, it was found that, in the rechargeable lithium batteries according to the invention, an oxidation begins in the desired voltage range of 4.7 V or higher, particularly preferably at 4.85 V or higher, especially preferably at 4.9 V or higher, and thus protects the battery from overcharging.

The thiophenes of the general formula (I) are therefore surprisingly suitable as electrolyte additives for protection from overcharging in rechargeable lithium batteries.

The present invention furthermore therefore relates to the use of thiophenes of the general formula (I)

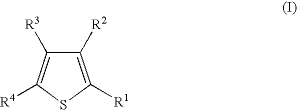

in which

R¹ to R⁴ have the abovementioned meaning,

as an additive for nonaqueous electrolytes for protecting rechargeable lithium batteries having a maximum permissible cell voltage for use in the intended manner, preferably those having a maximum permissible cell voltage of 4 V or higher for use in the intended manner, from overcharging.

The present invention furthermore relates to a method for preventing the overcharging of rechargeable lithium batteries having a maximum permissible cell voltage for use in the intended manner, comprising

an anode comprising, preferably substantially consisting of, a material which is capable of incorporating lithium ions and releasing them again,

a cathode comprising, preferably substantially consisting of, a material which is capable of releasing lithium ions and incorporating them again,

a separator,

a nonaqueous electrolyte substantially comprising one or more solvents and one or more conductive salts optionally embedded in a polymeric gel matrix,

characterized in that a thiophene of the general formula (I)

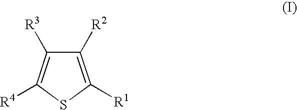

in which

R¹ to R⁴ have the abovementioned meaning,

is added to the nonaqueous electrolyte, which thiophene undergoes a chemical reaction at a voltage which is greater than the maximum permissible cell voltage of the battery for use in the intended manner, with the result that overcharging of the battery is counteracted.

It is assumed that the chemical reaction which the thiophenes of the general formula (I) undergo at the abovementioned voltage is preferably an oxidation.

This is preferably a method characterized in that the thiophene of the general formula (I) is added to the electrolyte in an amount of from 0.01 to 10% by volume, preferably in an amount of from 1 to 7% by volume, particularly preferably in an amount of from 2 to 5% by volume.

This method is furthermore preferably used for preventing the overcharging of rechargeable lithium batteries having a maximum permissible cell voltage of 4 V or higher for use in the intended manner.

This is furthermore preferably a method characterzied in that the voltage at which the thiophene of the general formula (I) undergoes chemical reaction is 4.7 V or higher, particularly preferably 4.85 V or higher, especially preferably 4.9 V or higher. The values of the voltages stated above and below relate to the potential of the reversible lithium electrode in 1 molar solution of Li ions.

As a result of the chemical reaction, the internal resistance of the battery increases on reaching this voltage to such an extent that a further substantial voltage increase and hence also further charging of the battery are not possible. The lithium battery according to the invention is thus effectively protected from overcharging which, for example for reasons described at the outset, can end in runaway of the battery and fire.

The invention is further described by way of the following non-limiting examples.

### EXAMPLES

A battery-like cell consisting of a T-shaped 0.5″ PTFE (polytetrafluoroethylene/polytetrafluoroethylene ether copolymer) pipe connector whose three ends carry a thread (“housing”), having 3 screw unions and PTFE sealing rings, a lithium anode on steel, a lithium nickel cobalt oxide cathode film on steel, a glass wool separator, and a nonaqueous electrolyte, is produced as follows in an argon glovebox:

A lithium anode on steel is obtained by pressing it out from a 0.38 mm thick lithium foil by means of the end face of a steel cylinder whose lateral surface is wound with an inert film (of polypropylene) and which fits exactly the orifices of the T-shaped pipe. A cathode film is obtained by mixing 85% by weight of lithium nickel cobalt oxide [LiNi_{0.8}Co_{0.2}O₂] with 10% by weight of Super Carbon Black® and 5% by weight of Hostaflon® powder in a mortar and rolling said mixture on a three-roll mill to give a self-supporting film about 100 μm thick. A cathode comprising about 20 mg of active material and having a diameter of 12 mm is punched out of this film.

A commercially available electrolyte (Merck LP 71) which consists of a 1 M solution of lithium hexafluorophosphate in a 1:1:1 mixture of ethylene carbonate, diethyl carbonate and dimethyl carbonate is used. The electrolyte additive (thiophene of the general formula (I)) in an amount stated in each case below is added to this electrolyte.

The cell is assembled by pushing a steel cylinder whose lateral surface is wound with inert film into an orifice of the housing and locking it with a screw union and a sealing ring. The cathode film is then inserted and is covered with a glass wool separator. The steel cylinder with the lithium anode is then introduced through the opposite orifice of the housing and is pushed up to the separator. Thereafter, about 1 ml of electrolyte with electrolyte additive is introduced and the separator is rendered gas-free and intimate contact is established between anode, separator and cathode by vigorously pressing the two steel cylinders against one another. The anode steel cylinder is screwed tight in this position. The third orifice is closed with a further steel cylinder so that no gas bubbles remain behind in the supernatant electrolyte.

The following procedure is adopted for determining the voltage at which the electrolyte additive reacts and displays its overcharge-preventing effect:

The cells described above are charged galvanostatically (with constant current) at 0.4 C to 4.3 V and then recharged potentiostatically (with constant voltage) at 4.3 V to 0.04 C. The cell is then overcharged galvanostatically at a charging rate of 1 C and the variation of the cell voltage is plotted.

For determining the reversibility of the first cycle, the cell is charged at C/15 to 4.3 V and in each case discharged to 3.0 V. The ratio of specific discharging capacity to specific charging capacity designates the reversibility of the first cycle.

The x C stated is a current which relates to the specific charging or discharging capacity, i.e. is independent of the actual mass of the electrodes. 1/x is the time for which the current has to be applied in order to reach the maximum charging capacity of the cell (at the chosen final voltage). C/15 accordingly means that a current which charges the electrode to the desired voltage in 15 hours is applied. A current of 0.04 C means that with this current it takes 25 hours to reach the maximum charging capacity at the specified voltage.

### Example 1 (Comparative Example):

In the following comparative example 1, the electrolyte comprises no electrolyte additive.

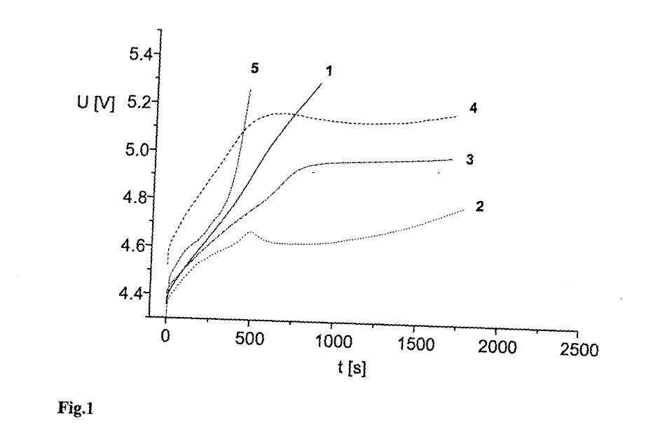

3 cells were produced as described above, charged to 4.3 V and recharged potentiostatically at 4.3 V to 0.04 C. Further charging was then effected galvanostatically at 1 C. The cell voltage increases sharply to 5.3 V in the course of 12 min (cf. curve 1 in FIG. 1).

3 further cells were produced as described above, charged at C/15 to 4.3 V, potentiostatically recharged at 4.3 V to 0.04 C and discharged again at C/15. The reversibility is 95.0% in the first cycle.

### Example 2 (Comparative Example):

In the following comparative example 2, the electrolyte comprises 2% by volume of 3-chloro-thiophene. 3 cells were produced as described above, charged to 4.3 V and potentiostatically recharged at 4.3 V to 0.04 C. Further charging was then effected galvanostatically at 1 C. The cell voltage increases sharply to 4.55 V. The curve then levels out, a small maximum occurs and the cell voltage then increases slowly again (cf. curve 2 in FIG. 1).

3 further cells were produced as described above, charged at C/15 to 4.3 V, potentiostatically recharged at 4.3 V to 0.04 C and discharged again at C/15. The reversibility is 93.5% in the first cycle.

### Example 3 (According to the Invention):

In the following example 3 according to the invention, the electrolyte comprises 5% by volume of thiophene-3-carbonitrile.

3 cells were produced as described above, charged to 4.3 V and potentiostatically recharged at 4.3 V to 0.04 C. Further charging was then effected galvanostatically at 1 C. The cell voltage increases to 4.95 V and remains at this level (cf. curve 3 in FIG. 1).

3 further cells were produced as described above, charged at C/15 to 4.3 V, potentiostatically recharged at 4.3 V to 0.04 C and discharged again at C/15. The reversibility is 92.7% in the first cycle.

### Example 4 (According to the Invention):

In the following Example 4 according to the invention, the electrolyte comprises 2% by volume of thiophene-2-carbonitrile.

3 cells were produced as described above, charged to 4.3 V and potentiostatically recharged at 4.3 V to 0.04 C. Further charging was then effected galvanostatically at 1 C. The cell voltage increases sharply to 5.15 V. The curve then flattens out, a small maximum occurs and the cell voltage then increases again only slowly (cf. curve 4 in FIG. 1).

3 further cells were produced as described above, charged at C/15 to 4.3 V, potentiostatically recharged at 4.3 V to 0.04 C and discharged again at C/15. The reversibility in the first cycle is 88.7%.

### Example 5 (Comparative Example):

In the following comparative example 5, the electrolyte comprises 5% by volume of thiophene-3-acetonitrile (U.S. Pat. No. 6,074,777).

3 cells were produced as described above, charged to 4.3 V and potentiostatically recharged at 4.3 V to 0.04 C. Further charging was then effected galvanostatically at 1 C. The cell voltage increases sharply in the course of 8 min to 5.3 V (cf. curve 5 in FIG. 1).

3 further cells were produced as described above, charged at C/15 to 4.3 V, potentiostatically recharged at 4.3 V to 0.04 C and discharged again at C/15. The reversibility is 94.0% in the first cycle.

The invention is further described with reference to FIG. 1. FIG. 1 shows a comparison of the variation of the cell voltage U after charging to 4.3 V with further charging at 1 C. In the figure, the cell voltage U is plotted in V (volts) against the time t in s (seconds). Curves 1 to 5 correspond in each case to the variation in the cell voltage in the case of cells with additives according to examples 1 to 5:

| | |
|---|---|
| Curve 1: | no additive (example 1) |
| Curve 2: | 2% by volume of 3-chloro-thiophene (example 2) |
| Curve 3: | 5% by volume of thiophene-3-carbonitrile (example 3) |
| Curve 4: | 2% by volume of thiophene-2-carbonitrile (example 4) |
| Curve 5: | 5% by volume of thiophene-3-acetonitrile (example 5) |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Rechargeable lithium battery having a maximum permissible cell voltage for use in the intended manner, comprising
an anode comprising a material which is capable of incorporating lithium ions and releasing them again,
a cathode comprising a material which is capable of releasing lithium ions and incorporating them again,
a separator,
a nonaqueous electrolyte comprising one or more solvents and one or more conductive salts optionally embedded in a polymeric gel matrix,
characterized in that the nonaqueous electrolyte additionally comprises a thiophene of the general formula (I) 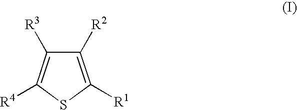
in which
R¹ to R⁴, independently of one another, are H, C₁-C₁₈-alkyl, C₁-C₁₈haloalkyl, C₁-C_{1 8}-alkoxy, C₁-C₁₈-haloalkoxy, halogen or pseudohalogen, with the proviso that at least one of the radicals R¹ to R⁴ is CN.

2. Rechargeable lithium battery according to claim 1, characterized in that R¹ to R⁴, independently of one another, are H, C₁-C₆-alkyl, C₁-C₆-fluoroalkyl, C₁-C₆-alkoxy, C₁-C₆-fluoroalkoxy, F, Cl or CN, with the proviso that at least one of the radicals R¹ to R⁴ is CN.

3. Rechargeable lithium battery according to claim 1, characterized in that R¹ to R⁴, independently of one another, are H, with the proviso that at least one of the radicals R¹ to R⁴ is CN.

4. Rechargeable lithium battery according to claim 1, characterized in that the nonaqueous electrolyte comprises a thiophene of the general formula (I) in an amount of from 0.01 to 10% by volume.

5. Rechargeable lithium battery according to claim 1, characterized in that the nonaqueous electrolyte comprises a thiophene of the general formula (I) in an amount of from 2 to 5% by volume.

6. Rechargeable lithium battery according to claim 1, characterized in that the anode comprises
metallic lithium or
alloys containing metallic lithium or
carbon-like optionally graphitic or non-graphitic materials or
carbon-based materials which contain further nonmetallic components in addition to carbon, or
ternary compounds of boron, carbon and nitrogen or
oxides or sulphides of main group and subgroup elements.

7. Rechargeable lithium battery according to claim 1, characterized in that the cathode comprises one or more transition metal chalcogenides or one or more mixed oxides of lithium and one or more transition metals and/or main group metals.

8. Rechargeable lithium battery according to claim 1, characterized in that the cathode comprises LiNi₁₋ₓCoₓO₂, LiNi_{1-x-y}CoₓAl_{y}O₂ or LiNi_{1-x-z}CoₓMn_{z}O₂,
in which
x is a number from 0.05 to 0.5,
y is a number from 0 to 0.3 and
z is a number from 0 to 0.5,
or mixtures of these with one another or mixtures of these with other mixed oxides of lithium with transition metals and/or main group metals.

9. Rechargeable lithium battery according to claim 1, characterized in that the separator is a porous polymer membrane or porous glass.

10. Rechargeable lithium battery according to claim 1, characterized in that the nonaqueous electrolyte comprises one or more solvents selected from the group of the esters of carbonic acid, esters or nitriles of carboxylic acids, lactones, ethers, alkanes, and perfluorinated alkanes, and one or more conductive salt(s) selected from LiBF₄, LiPF₆, LiAsF₆, LiClO₄, lithium salts of perfluorinated carboxylic acids and perfluorinated alkanesulphonic or arylsulphonic acids, lithium-bisfluoroalkylsulphonyl-imides, lithium-trisfluoroalkylsulphonylmethides, lithium fluoroalkyl-phosphates, lithium bis(oxalato)borates, and lithium bis((salicylato)borates) optionally embedded in a polymeric gel matrix.

11. Rechargeable lithium battery according to claim 1, characterized in that the nonaqueous electrolyte comprises, as a solvent, ethylene carbonate, propylene carbonate, diethyl carbonate, dimethyl carbonate, ethyl methyl carbonate or vinylene carbonate or a mixture of at least two of these carbonic esters.

12. Rechargeable lithium battery according to claim 1, characterized in that the maximum permissible cell voltage for use in the intended manner is 4 V or higher.

13. A process for protecting rechargeable lithium batteries having a maximum permissible cell voltage for use in the intended manner from overcharging comprising adding thiophenes of the general formula (I) 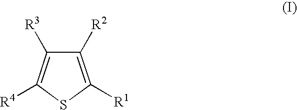
in which R¹ to R⁴have the meaning mentioned in claim 1,
as an additive for nonaqueous electrolytes.

14. The process according to claim 13, characterized by the rechargeable lithium batteries having a maximum permissible cell voltage of 4 V or higher for use in the intended manner.

15. Method for preventing the overcharging of rechargeable lithium batteries having a maximum permissible cell voltage for use in the intended manner, comprising an anode substantially comprising a material which is capable of incorporating lithium ions and releasing them again,
an anode comprising a material which is capable of incorporating lithium ions and releasing them again,
a cathode comprising a material which is capable of releasing lithium ions and incorporating them again,
a separator,
a nonaqueous electrolyte comprising one or more solvents and one or more conductive salts optionally embedded in a polymeric gel matrix,
comprising adding a thiophene of the general formula (I) 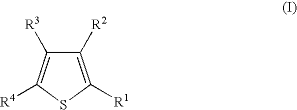
in which
R¹ to R⁴ have the meaning mentioned in claim 1,
to the nonaqueous electrolyte, which thiophene undergoes a chemical reaction at a voltage which is greater than the maximum permissible cell voltage of the battery for use in the intended manner, with the result that overcharging of the battery is counteracted.

16. Method according to claim 15, characterized in that the thiophene of the general formula (I) is added to the electrolyte in an amount of from 0.01 to 10% by volume.

17. Method according to claim 15, characterized in that the thiophene of the general formula (I) is added to the electrolyte in an amount of from 2 to 5% by volume.

18. Method according to claim 15, characterized in that the maximum permissible cell voltage of the battery for use in the intended manner is 4 V or higher.

19. Method according to claim 15, characterized in that the voltage at which the thiophene of the general formula (I) undergoes chemical reaction is 4.7 V or higher.
